(19) United States
(12) Patent Application Publication
(10) Pub. No.: US 2025/0042380 A1
(43) Pub. Date: Feb. 6, 2025

(54) ELECTROHYDRAULIC BRAKE CONTROL DEVICE FOR A MOTOR VEHICLE, AND BRAKE SYSTEM

(71) Applicant: Continental Automotive Technologies GmbH, Hannover (DE)

(72) Inventors: Christian Courth, Frankfurt (DE); Harald Biller, Eschborn (DE); Michael Hitzel, Rödermark (DE)

(73) Assignee: Continental Automotive Technologies GmbH, Hannover (DE)

(21) Appl. No.: 18/720,231

(22) PCT Filed: Dec. 5, 2022
(86) PCT No.: PCT/DE2022/200291

§ 371 Date: Jun. 14, 2024

(30) Foreign Application Priority Data
Dec. 14, 2021 (DE) 10 2021 214 332.6

(51) Int. Cl. B60T 13/68; B60T 13/74; B60T 17/02

(52) U.S. Cl. CPC B60T 13/686; B60T 13/745; B60T 17/02

(57) ABSTRACT

An electrohydraulic brake control device (200) for a motor vehicle for at least four hydraulically actuatable wheel brakes (8a-8d), said brake control device comprising an electrically actuatable pressure source (2), an electrically actuatable inlet valve (6a-6d) for each wheel brake, an electrically actuatable outlet valve (7a-7d) for each wheel brake, and a brake supply line (13), to which the at least four inlet valves (6a-6d) are connected, wherein an electrically actuatable circuit separation valve (40) is arranged in the brake supply line (13) in such a way that, when the circuit separation valve (40) is closed, the brake supply line (13) is hydraulically separated into a first line section (13a) and a second line section (13b), wherein the brake control device (200) comprises at least four hydraulic wheel ports (9a-9d) for connection to the wheel brakes (8a-8d), wherein the brake control device (200) comprises a first hydraulic port (62) for connection to a pressure medium reservoir (4) and a second hydraulic port (61) for connecting a further pressure source (5) to the brake control device (200), wherein the first line section (13a) of the brake supply line (13) is hydraulically connected to the electrically actuatable pressure source (2) and at least two of the at least four inlet valves (6a, 6b), and the second line section (13b) of the brake supply line (13) is hydraulically connected to the second hydraulic port (61) and the other of the at least four inlet valves (6c, 6d), and a brake system for a motor vehicle comprising such a brake control device (200).

### CROSS-REFERENCE TO RELATED APPLICATIONS

This application is a national stage der 35 U.S.C. § 371, of International Pa Application No. PCT/DE2022/200291, fled on Dec. 5, 2022, which claims priority to German patent application No. 10 2021 214 332.6, fled on Dec. 14, 2021, each of which is incorporated by reference.

### TECHNICAL FIELD

The technical field relates to an electrohydraulic brake control device and to a brake system including such a brake control device.

### BACKGROUND

A brake system having two electrically controllable pressure sources for a motor vehicle with four hydraulically actuatable wheel brakes is known from WO 2018/130483 A1. The brake system comprises not only wheel-specific electrically activatable inlet and outlet valves, but also an electrically activatable circuit separation valve and at least three further electrically activatable valves. These components are grouped together in a (single) brake control device. In addition, two electronic open-loop and closed-loop control units are provided, wherein one of the electronic open-loop and closed-loop control units activates the second pressure source and the inlet and outlet valves, while the first pressure source and all other valves are activated by the other electronic open-loop and closed-loop control unit.

DE 10 2018 222 478 A1 discloses a brake system comprising two electrically controllable pressure sources as well as a brake pedal-actuated master brake cylinder, wheel-specific electrically activatable inlet and outlet valves, an electrically activatable circuit separation valve, an electrically activatable pump valve for the second electrically controllable pressure source and a normally closed sequence valve for the first electrically controllable pressure source. In this case, the second electrically controllable pressure source, the pump valve associated therewith and the inlet and outlet valves are arranged in a first brake unit and the master brake cylinder with associated driver separation valve and simulator, the first electrically controllable pressure source, the normally closed sequence valve associated therewith and the circuit separation valve are arranged in a second brake unit.

There remains an opportunity to provide a low-cost electrohydraulic brake control device for an improved brake system that is suitable for highly automated driving.

There also remains an opportunity to keep the costs for the manufacture and assembly of the brake system as low as possible.

### SUMMARY

An electrohydraulic brake control device for at least four hydraulically actuatable wheel brakes includes an electrically actuatable pressure source, an electrically actuatable inlet valve for each wheel brake, an electrically actuatable outlet valve for each wheel brake, and a brake supply line, wherein the at least four inlet valves are connected to the brake supply line. An electrically actuatable circuit separation valve is arranged in the brake supply line in such a way that, when the circuit separation valve is closed, the brake supply line is hydraulically separated into a first line section and a second line section. The brake control device comprises at least four hydraulic wheel ports for connection to the wheel brakes. The brake control device furthermore includes a first hydraulic port for connection to a pressure medium reservoir and a second hydraulic port for connecting a further pressure source for the actuation of the wheel brakes to the brake control device. In this system, the first line section of the brake supply line is hydraulically connected to the electrically actuatable pressure source and at least two of the at least four inlet valves, and the second line section of the brake supply line is hydraulically connected to the second hydraulic port and the other of the at least four inlet valves.

Thus, when the circuit separation valve is open, the at least four wheel brakes can be actuated by means of the electrically actuatable pressure source of the brake control device and/or by means of the connected further pressure source. When the circuit separation valve is closed, the at least two wheel brakes connected to the first line section can be actuated by means of the pressure source of the brake control device, and the other wheel brakes, which are connected to the second line section, can be actuated by means of the further pressure source.

The brake control device according to the disclosure offers the advantage that a further (second), in particular electrically actuatable, pressure source can be arranged in the motor vehicle at a distance from the brake control device, and the second pressure source and the brake control device have to be connected to one another at most by one pressure-resistant hydraulic connecting element, wherein all the wheel brakes can be actuated by means of the second pressure source and the pressure source of the brake control device.

The further pressure source may be an electrically actuatable pressure source.

The electrohydraulic brake control device may also include an electrically actuatable separation valve, which is arranged hydraulically between the second hydraulic port for the further pressure source and the second line section of the brake supply line. By closing the separation valve, for example in the event of a leak in the further (second) pressure source, it is possible to prevent a flow of pressure medium from the brake control device, via the second hydraulic port, into the further pressure source. Moreover, the further pressure source can be hydraulically separated from the brake supply line by means of the separation valve, for example if the brake system is to be or must be operated in an operating mode (for example in the event of an electrical failure of the further pressure source) in which the at least four wheel brakes are pressurized by means of the pressure source of the brake control device.

The separation valve may also be designed to be normally open. Thus, no activation of the separation valve is necessary if the wheel brakes are to be actuated by means of the further pressure source connected to the second hydraulic port. Possibly disturbing switching noises are thereby prevented. In addition, power consumption is reduced. Moreover, this ensures that, when it is in the switched-off state, the brake control device is connected to the pressure-resistant hydraulic connecting element, which is preferably under atmospheric pressure in this state.

The circuit separation valve may be designed to be normally open. Thus, no activation of the circuit separation valve is necessary if all the wheel brakes are to be actuated by means of the same pressure source (pressure source of the brake control device or further pressure source). This reduces the power consumption of the brake system and avoids potentially disturbing valve switching noises.

The second hydraulic port of the brake control device is preferably designed for a pressure-resistant connection. For actuation of the wheel brakes, the wheel ports of the brake control device are also designed for a pressure-resistant connection. The first hydraulic port of the brake control device is preferably designed for a non-pressure-resistant (e.g. atmospheric) attachment.

A pressure-resistant connecting element or a pressure-resistant attachment/connection is preferably understood to mean that the connecting element or the attachment/connection is configured for a maximum operating pressure of one of the pressure sources, in particular the first pressure source, and/or the wheel brakes. The pressure-resistant connecting element or the pressure-resistant attachment/connection is particularly preferably configured for a pressure of about 180-220 bar. The pressure-resistant connecting element or the pressure-resistant attachment/connection is very particularly preferably configured for a pressure of about 200 bar.

A non-pressure-resistant connecting element or a non-pressure-resistant attachment/connection is understood to mean that the connecting element or the attachment/connection is not designed for the maximum operating pressure of the wheel brakes. A non-pressure-resistant connecting element or a non-pressure-resistant connection is configured for a maximum pressure of about 10 bar.

The electrohydraulic brake control device preferably does not include any other hydraulic port in addition to the wheel ports, the first hydraulic port and the second hydraulic port.

A pressure sensor may be connected to the first line section, to which the pressure source is connected. By means of the pressure sensor, the pressure produced by the pressure source of the electrohydraulic brake control device can be measured. This is advantageous for monitoring protection against bursting when circuit separation is active, that is to say when the circuit separation valve is closed.

The outlet valves may be connected to the first hydraulic port. Thus, pressure medium can be released into the pressure medium reservoir to reduce pressure in the wheel brakes.

The pressure source of the electrohydraulic brake control device may be connected to the first hydraulic port on the suction side to enable pressure medium to be drawn in from the pressure medium reservoir. The pressure source of the electrohydraulic brake control device is particularly preferably connected to the first hydraulic port without the interposition of an electrically actuatable valve. In this way, it is possible to achieve a suction resistance for the pressure source which is as low as possible.

According to another embodiment of the brake control device, the pressure source is of dual- or multi-circuit design. The pressure source may be designed as a dual-piston pump or a multi-piston pump, which has already been used successfully for many years in conventional ESC brake systems. Here, the suction sides of the dual- or multi-circuit pressure source are interconnected and connected to the first hydraulic port.

The pressure sides of the dual- or multi-circuit pressure source may be interconnected and connected to the first line section of the brake supply line.

As an alternative embodiment, one of the pressure sides of the dual- or multi-circuit pressure source is connected to the first line section of the brake supply line, and another pressure side of the dual- or multi-circuit pressure source is connected to the second line section of the brake supply line.

A check valve that opens in the direction of the second line section of the brake supply line may be connected in parallel with the separation valve, the check valve improving the volume flow from the further pressure source to the brake supply line.

An electrically actuatable, in particular normally closed, further separation valve may be connected in parallel with the separation valve. In this way, it is possible to use valves that can be manufactured at low cost, e.g., a large normally closed valve in parallel with a small normally open valve.

The electrohydraulic brake control device may include a valve block and an electronic controller. The pressure source, the inlet and outlet valves and the circuit separation valve may be activated by the electronic controller. As a particular preference, the separation valve is also activated by the electronic controller.

The pressure source, the inlet and outlet valves, the circuit separation valve and the separation valve may be activated exclusively by the electronic controller of the brake control device.

The first hydraulic port of the brake control device may be connected via a hydraulic connecting line to a pressure medium reservoir. The hydraulic connecting line between the brake control device and the pressure medium reservoir does not need to be of pressure-resistant design. The hydraulic connecting line between the brake control device and the pressure medium reservoir advantageously has a larger diameter than a pressure-resistant hydraulic connecting element between the brake control device and the further pressure source.

The disclosure also relates to a brake system including an electrohydraulic brake control device as described herein and a second electrohydraulic brake control device having a further or second electrically actuatable pressure source. The electrohydraulic brake control device and the second electrohydraulic brake control device are preferably connected to one another by at most one pressure-resistant hydraulic connecting element.

Further, non-pressure-resistant connecting elements between the brake control device and the second brake control device are possible.

The brake control device and the second brake control device are embodied in such a way that they are connected to one another by at most one pressure-resistant hydraulic connecting element. The brake control device and the second brake control device may be connected to one another by a plurality of hydraulic connecting elements, but at most one—in the sense of only one—of these hydraulic connecting elements is designed to be pressure-resistant, namely the pressure-resistant hydraulic connecting element. Any other hydraulic connecting elements are not designed to be pressure-resistant.

The brake control device and the second brake control device may be connected to one other by only one hydraulic connecting element, wherein this connecting element is designed to be pressure-resistant, that is to say is the pressure-resistant hydraulic connecting element.

Further, non-pressure-resistant connecting elements or connections or connecting lines are possible. The brake control device may be connected to a pressure medium reservoir via a non-pressure-resistant hydraulic connection. The second brake control device may be connected to the pressure medium reservoir via a non-pressure-resistant hydraulic connection.

The second electrically actuatable pressure source may be connected to a hydraulic port of the second electrohydraulic brake control device, and the second hydraulic port of the electrohydraulic brake control device is connected to the hydraulic port of the second electrohydraulic brake control device by means of the pressure-resistant hydraulic connecting element.

In addition to the pressure source of the electrohydraulic brake control device and the second pressure source of the second electrohydraulic brake control device, the brake system preferably does not comprise any further pressure source for building up a brake pressure for actuating the wheel brakes.

The brake control device includes one inlet valve and one outlet valve per wheel brake. At each wheel brake, it is preferred that the inlet valve is arranged hydraulically between the brake supply line and the associated wheel port, and the outlet valve is arranged hydraulically between the associated wheel port and the first hydraulic port. The inlet and outlet valves are used for setting wheel-specific brake pressures as required, these being derived from the brake supply pressure in the brake supply line.

As another option, the inlet valves pass the brake supply pressure on to the wheel ports in the unactivated state (i.e., the inlet valves are normally open), and the outlet valves prevent pressure medium from flowing out of the wheel brakes in the unactivated state (i.e., the outlet valves are normally closed).

The outlet valves may be connected via a common hydraulic connection (referred to as a return line) to the first hydraulic port. As a particular preference, the pressure source is hydraulically connected by its suction port (suction side or, where applicable, its suction sides) to the return line or the first hydraulic port. Thus, a single non-pressure-resistant connecting element between the brake control device and the pressure medium reservoir is possible.

The first line section is hydraulically connected to the pressure source and at least two of the at least four inlet valves, or the first line section connects the pressure source hydraulically to at least two of the at least four inlet valves. The second line section is hydraulically connected to the second hydraulic port or the separation valve and to the other, in particular at least two, of the at least four inlet valves, or the second line section connects the second hydraulic port or the separation valve hydraulically to the other, in particular at least two, of the at least four inlet valves.

By means of the circuit separation valve, the brake system can as it were be separated or divided up into two brake circuits. In this case, in one (first) brake circuit, the pressure source is hydraulically connected to the at least two of the at least four inlet valves, and in the other (second) brake circuit, the further pressure source is hydraulically connected via the second hydraulic port, and in particular the separation valve, to the other inlet valves of the at least four inlet valves. In a combined operating mode of the brake system, the wheel brakes which are assigned to the first brake circuit can thus be actuated by means of the pressure source, while the wheel brakes which are assigned to the second brake circuit are actuated by means of the further pressure source.

The wheel brakes of a brake circuit are preferably each assigned to one vehicle axle. As a particular preference, the wheel brakes of the first brake circuit are assigned to the rear axle, and the wheel brakes of the second brake circuit are assigned to the front axle.

According to a one embodiment, the brake system includes a first electronic controller, which is part of the electrohydraulic brake control device and which activates the electrical components (e.g., the pressure source, the inlet and outlet valves, the circuit separation valve, and, where applicable, the separation valve) arranged in the brake control device. The brake system furthermore may include a second electronic controller, which is part of the second electrohydraulic brake control device and which activates the electrical components (in particular the further (or second) pressure source) arranged in the second brake control device.

According to one embodiment, the brake system includes an actuating unit for a vehicle driver, wherein there is no mechanical-hydraulic connection between the actuating unit and the wheel brakes.

The brake system as described herein offers the advantage that the number of electrically actuatable valves is small. Furthermore, it offers the advantage that the number of hydraulic connections, in particular the hydraulic connections between the components or brake control devices of the brake system, is small. Thus, the brake system can be manufactured and assembled at low cost.

Division into a brake control device as described herein and a further pressure source or a second brake control device with a further (or second) pressure source offers the advantage over an implementation in just one brake control device that the two brake control devices are each smaller and lighter and therefore easier to handle. They can also be manufactured more easily in existing production plants. On the other hand, when divided into two brake control devices, each hydraulic connection between these brake control devices leads to considerable effort and costs. It is therefore particularly advantageous to keep the number of hydraulic connections as low as possible. It has been shown that it is advantageous to separate the various functions of hydraulic connections as clearly as possible. This means that connections via which pressure medium is drawn in can be designed with the largest possible diameter so that they have the smallest possible hydraulic resistance. For this, it is advantageous if such connections do not have to be pressure-resistant. Conversely, pressure-bearing connections should not have a suction function. This is ensured by the brake control device as described herein.

The disclosed subject matter also offers the advantage that, by virtue of the choice and arrangement of the electrically actuatable valves in the brake control devices, the associated electronic partitioning and, in particular, the association between the electrically actuatable valves and the electronic controllers of the brake control devices allow a clear separation between the properties of the hydraulic connections.

The disclosed subject matter furthermore offers the advantage that, even in the event of a failure of one of the two redundant electrical pressure sources, for example owing to a failure of the electrical energy source assigned thereto or of the electronic controller assigned thereto or a mechanical fault or a leak in the pressure source itself, the brake system can maintain the most important residual braking functions.

The brake system disclosed herein is therefore particularly suitable for the realization of highly automated driving functions.

### BRIEF DESCRIPTION OF THE FIGURES

Further embodiments of the disclosure become apparent from the dependent claims and the following description with reference to figures, in which, schematically:

FIG. 1 shows a first exemplary embodiment of a brake system including a first exemplary embodiment of an electrohydraulic brake control device,

FIG. 2 shows a second exemplary embodiment of a brake system including a second exemplary embodiment of an electrohydraulic brake control device, and

FIG. 3 shows a third exemplary embodiment of a brake system including a third exemplary embodiment of an electrohydraulic brake control device.

### DETAILED DESCRIPTION

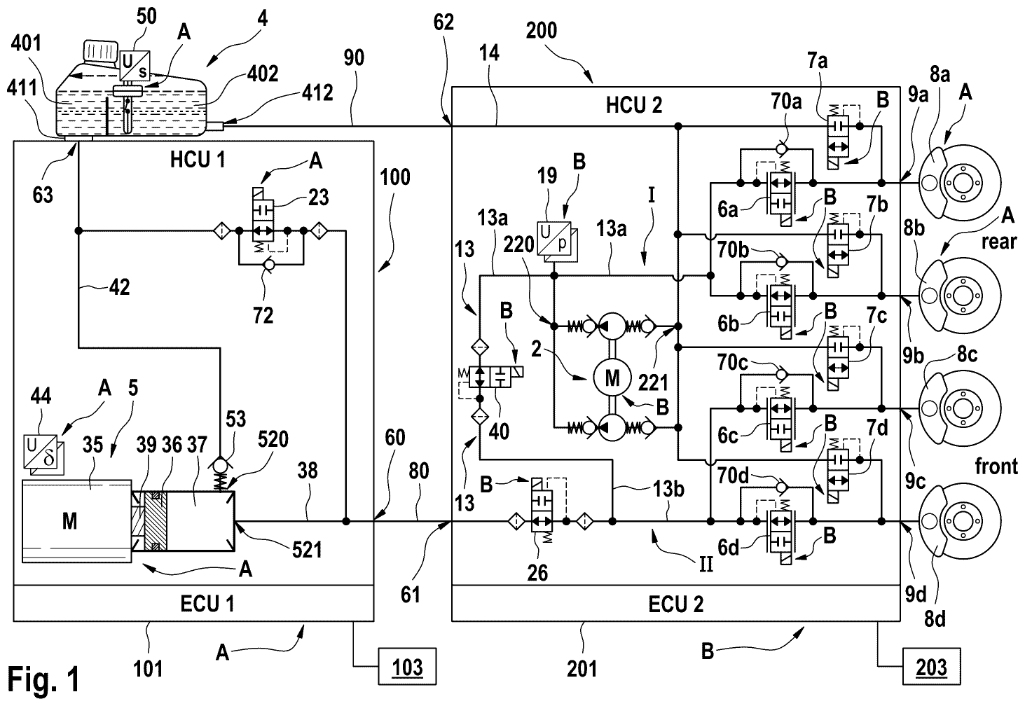

FIG. 1 illustrates, in highly schematic form, a first exemplary embodiment of a brake system for a motor vehicle including a first exemplary embodiment of an electrohydraulic brake control device 200. According to the example, the brake system is designed for actuating four hydraulically actuatable wheel brakes 8a-8d; an extension to more wheel brakes is easily possible. According to the example, the wheel brakes 8a, 8b are assigned to the rear axle (rear) and the wheel brakes 8c, 8d are assigned to the front axle (front) of the vehicle.

The brake system includes a first structural unit 100 (HECU1) designed, according to the example, as a first electrohydraulic brake control device with a valve block HCU1 and a first electronic controller 101 (ECU1), a second structural unit 200 (HECU2) designed, according to the example, as a second electrohydraulic brake control device with a valve block HCU2 and a second electronic controller 201 (ECU2), and a pressure medium reservoir 4.

The terms (first/second) structural unit and (first/second) electrohydraulic brake control device should therefore be understood as synonymous below.

The pressure medium reservoir 4, which is under atmospheric pressure, is advantageously arranged on the first structural unit 100. According to the example, the pressure medium reservoir 4 comprises two chambers, wherein the first chamber 401 is assigned a first reservoir port 411 and the second chamber 402 is assigned a second reservoir port 412.

A first electrically actuatable pressure source 5 is arranged in the first structural unit 100.

Arranged in the second structural unit 200 are a second electrically actuatable pressure source 2 and wheel-specific brake pressure modulation valves, which are designed as one electrically actuatable inlet valve 6a-6d per wheel brake 8a-8d and one electrically actuatable outlet valve 7a-7d per wheel brake 8a-8d.

The first pressure source 5 and the second pressure source 2 are connected on the pressure side to a brake supply line 13, to which the four inlet valves 6a-6d are connected. All four wheel brakes 8a-8d can thus be actuated by means of the first pressure source 5 or by means of the second pressure source 2. The brake supply line 13 is arranged in the second structural unit 200.

Arranged in the brake supply line 13 is an electrically actuatable circuit separation valve 40, and therefore, when the circuit separation valve 40 is closed, the brake supply line 13 is divided into a first line section 13a, to which the inlet valves 6a, 6b and the wheel brakes 8a, 8b are connected, and a second line section 13b, to which the inlet valves 6c, 6d and the wheel brakes 8c, 8d are connected. The second pressure source 2 is hydraulically connected to the first line section 13a, and the first pressure source 5 is hydraulically connected to the second line section 13b. When the circuit separation valve 40 is closed, the brake system is thus separated or divided into two hydraulic brake circuits I and II. Here, in the first brake circuit I, the pressure source 2 is connected to only the wheel brakes 8a and 8b (via the first line section 13a) and, in the second brake circuit II, the first pressure source 5 is connected to only the wheel brakes 8c and 8d (via the second line section 13b). The circuit separation valve 40 is advantageously designed to be normally open.

As already mentioned, the brake system includes, for each hydraulically actuatable wheel brake 8a-8d, an inlet valve 6a-6d and an outlet valve 7a-7d which are hydraulically interconnected in pairs via central ports and are each connected to a hydraulic wheel port 9a-9d of the second structural unit 200, to which the corresponding wheel brake 8a-8d is connected. A check valve 70a-70d which opens in the direction of the brake supply line 13 is connected in parallel with each of the inlet valves 6a-6d. The outlet ports of the outlet valves 7a-7d are connected via a common return line 14 to a hydraulic port 62 of the second structural unit 200, which is connected to the pressure medium reservoir 4, according to the example to the second reservoir port 412 thereof and to the chamber 402 thereof. The input ports of all inlet valves 6a-6d can be supplied by means of the brake supply line 13 (that is to say when the circuit separation valve 40 is open) with a pressure which is provided by the first pressure source 5 or, for example in the event of a failure of the first pressure source 5, by the second pressure source 2.

The second electrically controllable pressure source 2 of the second structural unit 200 includes a pressure port 220, which is hydraulically connected to the first line section 13a, and a suction port 221, which is hydraulically connected to the pressure medium reservoir 4, according to the example via return line 14 and port 62. Port 62, and thus the suction port (the suction side(s)) 221 of the pressure source 2, is directly connected via a line or a hose 90 to the pressure medium reservoir 4. This connection 90 does not carry any pressure and may therefore have a large diameter.

According to the example, port 62 is hydraulically connected by means of the connecting line/connecting hose 90 to the second reservoir port 412 (and thus the second chamber 402) of the pressure medium reservoir 4.

The first electrically controllable pressure source 5 of the first structural unit is in the form of a hydraulic cylinder-piston arrangement (or a single-circuit electrohydraulic actuator (linear actuator)), the piston 36 of which can be actuated, in particular advanced and retracted, in order to build up and dissipate a pressure in a pressure chamber 37, by a schematically indicated electric motor 35 via a likewise schematically illustrated rotation-translation mechanism 39. The piston 36 delimits the pressure chamber 37 of the pressure source 5. For the activation of the electric motor, a rotor position sensor 44 is provided, which detects the rotor position of the electric motor 35 and which is merely schematically indicated.

A system pressure line section 38 is connected to the pressure chamber 37 of the first electrically controllable pressure source 5. By means of line section 38, pressure source 5 or the pressure chamber 37 thereof is hydraulically connected to a hydraulic port 60 of the first structural unit 100, which is hydraulically connected via a hydraulic connecting element 80 to a hydraulic (pressure) port 61 of the second structural unit 200. Connection 80 is the only hydraulic pressure connection, in particular the only hydraulic connection, between the first structural unit 100 and the second structural unit 200. It is a hydraulic connection for transmitting a brake pressure to actuate the wheel brakes 8a-8d (hence pressure connection). Connecting element 80 must therefore be designed to be pressure-resistant, for example as a pressure-resistant brake hose.

The hydraulic (pressure) port 61 of the second structural unit 200 is hydraulically connected to the second line section 13b of the brake supply line 13.

According to the example, the pressure chamber 37 is hydraulically connected, via a (replenishment) line 42 formed in the first structural unit 100 to a hydraulic port 63 of the first structural unit 100, independently of the state of actuation of the piston 36. Port 63 is hydraulically connected to the pressure medium reservoir 4, according to the example to the first reservoir port 411 thereof and thus the first chamber 401 thereof. A check valve 53 which closes in the direction of the pressure medium reservoir 4 is arranged in the (replenishment) line 42. According to the example, the exemplary pressure source/cylinder-piston arrangement 5 has no breather holes.

Furthermore, according to the example, pressure chamber 37 is hydraulically connected via the line section 38 and an electrically actuatable, advantageously normally open, second separation valve 23 to the hydraulic port 63 (and the (replenishment) line 42). According to the example, a check valve 72 which opens in the direction of the pressure chamber 37 is connected in parallel with the second separation valve 23.

According to the example, the first structural unit 100 does not include any other hydraulic port in addition to the (pressure medium reservoir) port 63 and the (pressure) port 60.

According to the example, the second electrically controllable pressure source 2 is designed as a dual-piston pump, but it can also be designed as a dual- or multi-circuit pressure source of some other kind. The suction sides of the dual- or multi-circuit pressure source are advantageously interconnected and hydraulically connected to the return line 14 and thus to the port 62 and the pressure medium reservoir 4.

According to the example, the second electrically controllable pressure source 2 of the second structural unit 200 is designed as a dual-piston pump, the two pressure sides of which are interconnected (at the pressure port 220) and the two suction sides of which are interconnected (at the suction port 221). Suction port 221 (and thus the two suction sides) of the pressure source 2 is (are) hydraulically connected to the return line 14 and thus to the port 62 and the pressure medium reservoir 4. Pressure port 220 (and thus the two pressure sides) of the pressure source 2 is (are) connected to the first line section 13a of the brake supply line 13.

According to an alternative embodiment, which is not illustrated, the pressure sides of the second pressure source, e.g., the dual- or multi-circuit pressure source or the dual-piston pump, are not interconnected. It is advantageous if one of the pressure sides of the second pressure source is connected to the first line section 13a of the brake supply line 13, and another pressure side of the second pressure source is connected to the second line section 13b of the brake supply line 13.

An electrically actuatable, advantageously normally open, separation valve 26 is preferably arranged in the second structural unit 200 in addition to the pressure source 2 and the brake pressure modulation valves 6a-6d, 7a-7d. Separation valve 26 is arranged hydraulically between the port 61 of the second structural unit 200 and the second line section 13b of the brake supply line 13. Thus, the first pressure source 5 is separably connected via the port 61 and the separation valve 26 to the second line section 13b or the brake supply line 13.

According to the example, the brake system comprises, in the brake circuit I (line section 13a), a pressure sensor 19, which is thus assigned to the second pressure source 2. This is advantageous for protection against bursting when the circuit is divided, that is to say when the circuit separation valve 40 is closed. However, the pressure sensor 19 may also be arranged in the brake circuit II or a second pressure sensor may be provided, such that each of the two brake circuits I and II can be directly monitored by means of a pressure sensor.

According to the example, the brake system comprises, for leakage monitoring purposes, a level-measuring device 50 for determining a pressure medium level in the pressure medium reservoir 4.

The structural unit 200 thus comprises four hydraulic wheel ports 9a-9d for connection to the wheel brakes 8a-8d, a hydraulic port 62 for connection to the pressure medium reservoir 4, and the hydraulic (pressure) port 61 for connection of the pressure source 5. Port 62 is advantageously designed to be pressure-resistant, while the wheel ports 9a-9d and the port 61 are designed to be pressure-resistant.

According to the example, the structural unit 200 does not include any other hydraulic port in addition to the wheel ports 9a-9d, the (pressure medium reservoir) port 62 and the (pressure) port 61.

According to the example, the pressure source 5, the check valve 53, the separation valve 23, the check valve 72 and the line sections 38, 42 are arranged in the first structural unit 100 or in the first valve block HCU1.

Pressure source 2, inlet and outlet valves 6a-6d, 7a-7d, separation valve 26 and the brake supply line 13 with the circuit separation valve 40 and its line sections 13a, 13b (and also the wheel line sections, not denoted specifically, between the inlet and outlet valves, on the one hand, and the wheel ports, on the other hand) are arranged in the structural unit 200 or in the valve block HCU2. Pressure sensor 19 is likewise arranged in the structural unit 200.

Each valve block HCU1, HCU2 is assigned an electronic controller 101, 201 (ECU1, ECU2). Each electronic controller 101, 201 comprises electrical and/or electronic elements (for example microcontrol devices, power modules, valve drivers, other electronic components, etc.) for activating the electrically actuatable components of the associated valve block (structural unit) and, if necessary, for evaluating the signals of the sensors assigned to this valve block (structural unit). The valve block and electronic controller are advantageously designed in a known manner as an electrohydraulic unit (HECU)/electrohydraulic brake control device.

For the electrical attachment, connection and supply of the individual electrical or electrically actuatable, activatable, evaluatable or similar components of the brake system, a first electrical partition A and a second electrical partition B are provided, which are electrically independent of one another.

In the figures, those electrical components which are assigned or belong to the first electrical partition A are indicated by an arrow A, while those electrical components which are assigned or belong to the second electrical partition B are indicated by an arrow B.

The electronic controller 101 is assigned to or belongs to the first electrical partition A, while the second electronic controller 201 is assigned to or belongs to the second electrical partition B. Accordingly, the electronic controller 101 and the second electronic controller 201 are electrically independent.

To supply the brake system with electrical energy, a first electrical energy source 103, for example a vehicle electrical system, and a second electrical energy source 203, for example a vehicle electrical system, which is independent of the first energy source are provided. The first electrical energy source 103 supplies the first electrical partition A with energy and the second electrical energy source 203 supplies the second electrical partition B.

The first electronic controller 101 activates the first pressure source 5. Accordingly, the first pressure source 5 is assigned to or associated with the first electrical partition A. According to the example, the first pressure source 5 is supplied with energy (from the first electrical energy source 103) via the first electronic controller 101.

The second electronic controller 201 activates the second pressure source 2. Accordingly, the second pressure source 2 is assigned to or associated with the second electrical partition B. According to the example, the second pressure source 2 is supplied with energy (from the second electrical energy source 203) via the second electronic controller 201.

According to the example, the first pressure source 5 can be or is activated exclusively by the first electronic controller 101, and the second pressure source 2 can be or is activated exclusively by the second electronic controller 201. It would basically be conceivable for the electric motor of a pressure source to be equipped, for example, with two electrically independent motor coils; it would thus be possible for the pressure source to be activated by the two independent electrical devices. This would however be associated with further redundancies, for example double connecting lines, etc., and would thus be more expensive.

The remaining components of the brake system are advantageously assigned to either the first electronic controller 101 (partition A) or the second electronic controller 201 (partition B). That is to say said components are activated or actuated by said controller and/or supplied with electrical energy by said controller, and/or are connected on the signal side to said controller and/or are evaluated by said controller. In order to avoid further redundancies, it is advantageously the case that a component is activatable or actuatable by, or suppliable with electrical energy by, or connected on the signal side to, or evaluatable by, only or exclusively one of the two electronic controllers 101, 201, but not the other electronic controller.

The inlet and outlet valves 6a-6d, 7a-7d are assigned to the second electrical partition B and are activated by the second electronic controller 201. The circuit separation valve 40 is likewise assigned to the second electrical partition B and is activated by the second electronic controller 201.

The separation valve 26 for separating the brake supply line 13 or the second line section 13b from the (pressure) port 61 of the structural unit 200 (and thus from the first pressure source 5) is assigned to the second electrical partition B and is activated by the second electronic controller 201.

Pressure sensor 19 is also assigned to the second electrical partition B. The signals from said sensor are fed to the second electronic controller 201 and evaluated and processed thereby.

The separation valve 23 of the first structural unit 100 is assigned to the first electrical partition A and is activated by the first electronic controller 101.

Furthermore, the signals from the level measuring device 50 are supplied to the first electronic controller 101 and evaluated and processed thereby.

The brake system preferably comprises electrically actuatable parking brakes on the rear wheels (rear). Said parking brakes are advantageously activated and actuated by the first electronic controller 101, denoted by A at the wheel brakes 8a, 8b in FIG. 1.

The exemplary brake system comprises a primary pressure source 5 and a secondary pressure source 2, each of which is electrically operated by an ECU (electronic control unit) and has a suction port and a pressure port. No brake fluid can flow into the pressure port 220 of the secondary pressure source 2 even in the electrically deenergized state. The primary pressure source 5 is preferably a linear actuator with a replenishment check valve 53 and the secondary pressure source 2 is a piston pump. The secondary pressure source 2 can preferably generate a higher pressure than the primary pressure source 5.

The suction ports 221 and 520 of the two pressure sources 2 and 5, respectively, are connected to a pressure medium reservoir 4, preferably each to one of two separate chambers (402, 401).

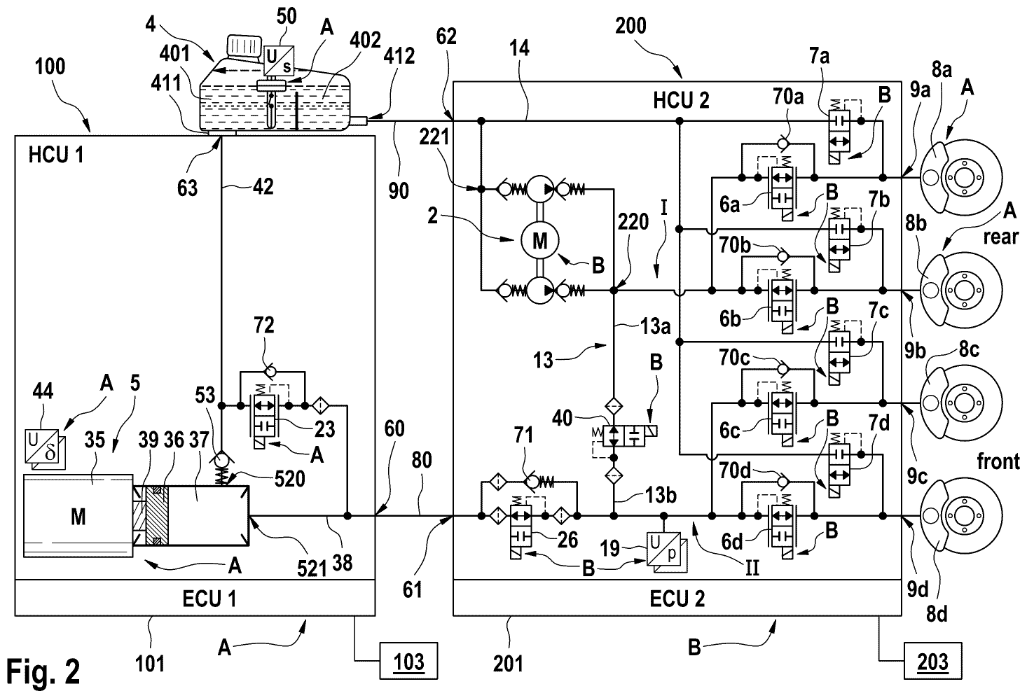

The pressure port 521 of the primary pressure source 5 is connected to a primary circuit node (second line section 13b) via an electromagnetic valve 26, also referred to as pressure activation valve. A check valve 71 can be connected in parallel with the valve 26 (see for example FIG. 2), which allows a volume flow from the primary pressure source 5 to the primary circuit node (13b).

The pressure port 220 of the secondary pressure source 2 is connected directly (without intermediate connection of a valve) to a secondary circuit node (first line section 13a).

The two circuit nodes (line sections 13a, 13b) are connected to one another via an electromagnetic valve 40, also referred to as a circuit separation valve.

The two circuit nodes are connected to wheel brakes 8a-8d via electromagnetic inlet valves 6a-6d, for example the primary circuit node (13b) is connected to the wheel brakes 8c, 8d of the front axle and the secondary circuit node (13a) is connected to the wheel brakes 8a, 8b of the rear axle.

The wheel brakes 8a-8d are connected to the pressure medium reservoir 4 via electromagnetic outlet valves 7a-7d.

The output port 521 of the primary pressure source 5 is connected to the pressure medium reservoir 4 via an electromagnetic valve 23, also referred to as pressure dissipation valve.

Valve 26, valve 40 and valve 23 may be designed to be normally open.

In the normal braking mode of the brake system, the pressure in the wheel brakes 8a-8d is built up by the primary pressure source 5 with the separation valve 23 closed. The pressure is dissipated to the primary pressure source 5 (return of the piston 36) or to the pressure medium reservoir 4 via the separation valve 23.

The wheel brake pressure is modulated by the inlet and outlet valves 6a-6d, 7a-7d on a wheel-by-wheel basis as required (for example in the case of an anti-lock braking control or other brake control function). If necessary, the separation valve 26 is closed so that the primary pressure source 5 can draw in additional volume from the pressure medium reservoir 4.

If a particularly high volume flow rate is required or requested, both pressure sources 5 and 2 may operate simultaneously in parallel. In this case, the pressure is dissipated at least partially via the separation valve 23, which may be designed as an analog valve, that is to say it can control its flow. If a particularly high pressure is requested, the separation valve 26 is preferably closed and the secondary pressure source 2 increases the pressure beyond the pressure of the primary pressure source 5.

Outside of braking operations, atmospheric pressure equalization is permanently ensured via separation valve 23 and separation valve 26.

In the event of a leak in the brake system, the circuit separation valve 40 is preferably closed and the system is thus divided into two independent hydraulic brake circuits I and II.

The separation valve 23 is preferably activated by the primary ECU 101 and is arranged in the first structural unit 100.

The separation valve 26 may be activated by the secondary ECU 201 and is arranged in the second structural unit 200, in which the inlet and outlet valves 6a-6d, 7a-7d and the circuit separation valve 40 are arranged, which are likewise activated by the secondary ECU 201.

The following description of operation in the event of a fault refers to this valve assignment.

If the primary system (structural unit 100) fails electrically, in particular the primary ECU 101 or the power supply 103 thereof (partition A failure), the secondary ECU 201 closes the separation valve 26 to build up pressure via the secondary pressure source 2. Pressure is dissipated via the separation valve 26 or via the outlet valves 7a-7d. The inlet and outlet valves are preferably activated by the secondary ECU 201 (partition B), so that the pressure can be modulated on a wheel-by-wheel basis.

If the secondary system (structural unit 200) fails electrically, in particular the secondary ECU 201 or the power supply 203 thereof (partition B failure), the pressure is built up and dissipated as in normal operation via the primary pressure source 5 and, if necessary, the separation valve 23. Wheel-specific pressure control has to be given up, but joint modulation of the wheel pressures remains possible in order to prevent the vehicle from being destabilized by wheel-locking.

The assignment of the valves to the two ECUs is preferably as described above, the circuit separation valve 40 is activated by the secondary ECU 201, and the system is divided into two structural units 100 and 200 with two hydraulic connecting lines, namely the pressure-resistant connecting element 80 and the unpressurized or non-pressure-resistant connecting line 90. These two structural units 100, 200 may each comprise one of the two ECUs, the assigned pressure source and the assigned valves.

FIG. 2 illustrates schematically a second exemplary embodiment of a brake system including a second exemplary embodiment of an electrohydraulic brake control device 200. In contrast to the first exemplary embodiment in FIG. 1, a check valve 71 is connected in parallel with the separation valve 26 of the second structural unit or of the second electrohydraulic brake control device 200, said check valve enabling a volume flow from the port 61 (and thus from the pressure source 5) to the line section 13b, in order to reduce the hydraulic resistance of the valve 26 in the pressure build-up direction. Furthermore, the pressure sensor 19 is arranged on the line section 13b (brake circuit II) in structural unit 200.

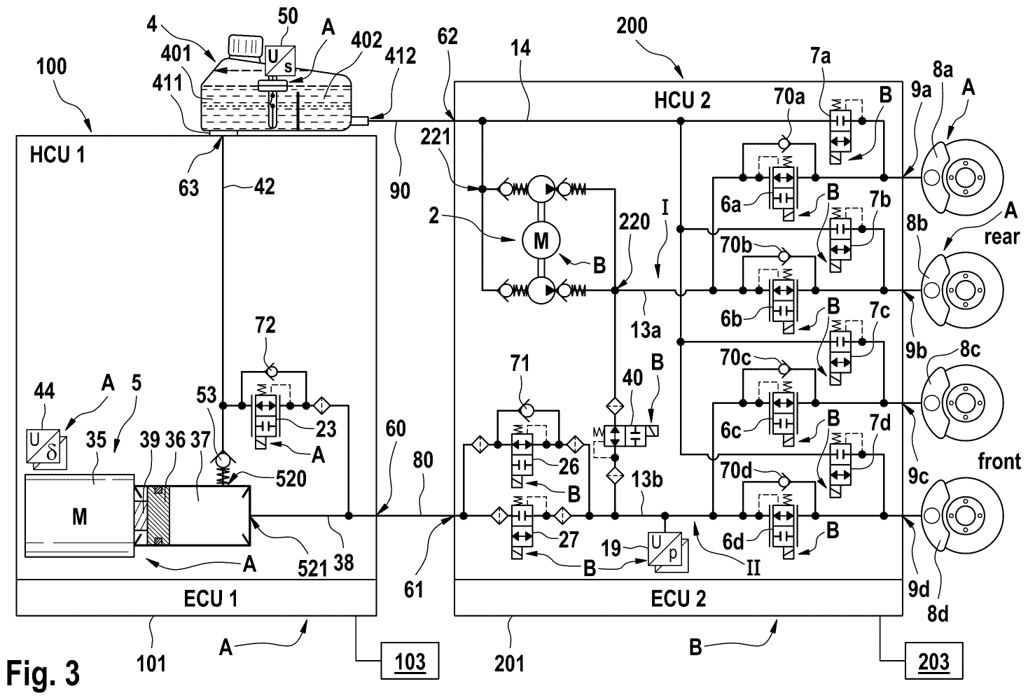

FIG. 3 illustrates schematically a third exemplary embodiment of a brake system including a third exemplary embodiment of an electrohydraulic brake control device 200. In contrast to the second exemplary embodiment of FIG. 2, another electrically actuatable valve 27 is provided in the second structural unit 200, the valve being designed to be normally closed. The valve is connected in parallel with the separation valve 26. Valve 27 is activated by the second electronic controller 201.

Compared to implementation in just one structural unit (in just one brake control device), division of the exemplary brake systems into two structural units (brake control devices) offers the advantage that both structural units are smaller and lighter and therefore easier to handle. They can also be manufactured more easily in existing production plants. When divided into two structural units, each hydraulic connection between these structural units will result in additional effort and additional costs. It is therefore advantageous to keep the number of hydraulic connections as low as possible. It is furthermore advantageous to isolate the various functions of hydraulic connections as clearly as possible. Connections via which pressure medium is drawn in should have as little hydraulic resistance as possible and therefore as large a diameter as possible. For this, it is advantageous if such connections do not have to be pressure-resistant. Conversely, pressure-bearing connections should not have a suction function.

The choice and arrangement of the electrically actuatable valves in the two structural units, the electronic partitioning and, in particular, the association between electrically actuatable valves and electronic controllers make possible these advantageous properties of the hydraulic connections of the two structural units. It is made possible for the two structural units to need only one pressure-resistant connection which hydraulically connects them to one another in addition to the unpressurized or non-pressure-resistant connections to the pressure medium reservoir. The at least four connections between the second structural unit 200 (or the wheel ports (9a-9d)) and the wheel brakes 8a-8d are also pressure-resistant connections.

1-17. (canceled)

18. An electrohydraulic brake control device for a motor vehicle having at least four hydraulically actuatable wheel brakes, said brake control device comprising:
an electrically actuatable pressure source;
an electrically actuatable inlet valve for each wheel brake;
an electrically actuatable outlet valve for each wheel brake;
a brake supply line connected to the at least four inlet valves;
an electrically actuatable circuit separation valve arranged in the brake supply line such that when the circuit separation valve is closed, the brake supply line is hydraulically separated into a first line section and a second line section;
at least four hydraulic wheel ports for connection to the wheel brakes;
a first hydraulic port for connection to a pressure medium reservoir; and
a second hydraulic port for connecting a further pressure source;
wherein the first line section of the brake supply line is hydraulically connected to the electrically actuatable pressure source and at least two of the at least four inlet valves; and
wherein the second line section of the brake supply line is hydraulically connected to the second hydraulic port and the other of the at least four inlet valves.

19. The electrohydraulic brake control device as claimed in claim 18, further comprising an electrically actuatable separation valve arranged hydraulically between the second hydraulic port and the second line section of the brake supply line.

20. The electrohydraulic brake control device as claimed in claim 19, wherein the separation valve is configured as normally open.

21. The electrohydraulic brake control device as claimed in claim 18, wherein the circuit separation valve is configured as normally open.

22. The electrohydraulic brake control device as claimed in claim 18, wherein said device does not include any other hydraulic port in addition to the wheel ports, the first hydraulic port, and the second hydraulic port.

23. The electrohydraulic brake control device as claimed in claim 18, further comprising a pressure sensor connected to the first line section and configured to measure the pressure produced by the pressure source.

24. The electrohydraulic brake control device as claimed in claim 18, wherein the outlet valves are connected to the first hydraulic port.

25. The electrohydraulic brake control device as claimed in claim 18, wherein the pressure source is connected to the first hydraulic port on a suction side without the interposition of an electrically actuatable valve.

26. The electrohydraulic brake control device as claimed in claim 18, wherein the pressure source is configured as a multi-piston pump with suction sides interconnected to one another and connected to the first hydraulic port.

27. The electrohydraulic brake control device as claimed in claim 18, further comprising a check valve that opens in the direction of the brake supply line and is connected in parallel with the separation valve.

28. The electrohydraulic brake control device as claimed in claim 18, further comprising an electrically actuatable, normally open, further separation valve connected in parallel with the separation valve.

29. The electrohydraulic brake control device as claimed in claim 18, further comprising a valve block and an electronic controller.

30. The electrohydraulic brake control device as claimed in claim 29, wherein the pressure source, the inlet and outlet valves, and the circuit separation valve are activated by the electronic controller.

31. The electrohydraulic brake control device as claimed in claim 30, further comprising an electrically actuatable separation valve arranged hydraulically between the second hydraulic port and the second line section of the brake supply line, wherein the separation valve is activated by the electronic controller.

32. A brake system for a motor vehicle having at least four hydraulically actuatable wheel brakes, said brake system comprising:
a first electrohydraulic brake control device, including
an electrically actuatable pressure source;
an electrically actuatable inlet valve for each wheel brake;
an electrically actuatable outlet valve for each wheel brake;
a brake supply line connected to the at least four inlet valves;
an electrically actuatable circuit separation valve arranged in the brake supply line such that when the circuit separation valve is closed, the brake supply line is hydraulically separated into a first line section and a second line section;
at least four hydraulic wheel ports for connection to the wheel brakes;
a first hydraulic port for connection to a pressure medium reservoir; and
a second hydraulic port for connecting a further pressure source;
wherein the first line section of the brake supply line is hydraulically connected to the electrically actuatable pressure source and at least two of the at least four inlet valves, and
wherein the second line section of the brake supply line is hydraulically connected to the second hydraulic port and the other of the at least four inlet valves; and
a second electrohydraulic brake control device including a second electrically actuatable pressure source, wherein the first electrohydraulic brake control device and the second electrohydraulic brake control device are connected to one another by at most one pressure-resistant hydraulic connecting element.

33. The brake system as claimed in claim 32, wherein the second electrically actuatable pressure source is connected to a hydraulic port of the second electrohydraulic brake control device, and in that the second hydraulic port of the first electrohydraulic brake control device is connected to the hydraulic port of the second electrohydraulic brake control device with the pressure-resistant hydraulic connecting element.

34. The brake system as claimed in claim 32, wherein in addition to the pressure source of the first electrohydraulic brake control device and the second pressure source of the second electrohydraulic brake control device, the brake system does not comprise any further pressure source for building up a brake pressure for actuating the wheel brakes.
